(19) United States
(12) Patent Application Publication
(10) Pub. No.: US 2026/0085761 A1
(43) Pub. Date: Mar. 26, 2026

(54) ROTARY VALVE

(71) Applicant: TI Automotive Technology Center GmbH, Rastatt (DE)

(72) Inventors: Chaoxiong Wu, Wuhan City (CN); Liu Qi, Jiangsu (CN); Artem Tuzin, Stutensee (DE); Florian Deibel, Sinzheim (DE)

(21) Appl. No.: 19/339,945

(22) Filed: Sep. 25, 2025

(30) Foreign Application Priority Data
Sep. 25, 2024 (DE) 102024105522.5

(51) Int. Cl. F16K 11/085; F16K 25/00

(52) U.S. Cl. CPC F16K 11/0853; F16K 25/005

(57) ABSTRACT

A rotary valve having a valve housing which is provided with flow channels and in which a valve core is rotatably supported. The valve core is provided with a channel structure and the valve housing has a chamber wall into which the flow channels open. A sealing element is associated with the valve core, which sealing element seals the gap between the chamber wall and the valve core. The channel structure has an inlet channel.

### RELATED APPLICATIONS

The present disclosure claims priority to and the benefit of German Application 102024105522.5, filed on Sep. 25, 2024, the entire contents of each of which are incorporated herein by reference.

### FIELD

The present disclosure relates to a rotary valve with a valve housing in which a valve core is rotatably supported, and particularly to a sealing element which seals the gap between the chamber wall and the valve core.

### BACKGROUND

A valve of this type is known from CN 117108791 A. The valve described there is formed as a rotary valve and is used in cooling circuits to control the coolant flow. A cooling fluid can flow in and out of the valve through the fluid openings that open into the valve housing. The channel structure which is introduced into the valve core controls the coolant flow, wherein, depending on the design and number of fluid channels, different cooling circuits can be controlled, the volume flow of the coolant can be regulated and/or the flow direction of the coolant can be adjusted.

With a rotary valve, the coolant flow is adjusted by rotating the valve core, wherein the corresponding actuator for rotating the valve core is formed in a simple manner and is easy to control. Accordingly, rotary valves and the associated actuators are inexpensive to manufacture and require little installation space.

Accordingly, rotary valves are used in temperature control circuits in the field of electromobility. The components of electric vehicles whose temperature needs to be controlled are, in particular, electrical energy storage devices, the power electronics or plug connections of fast-charging devices. The temperature control medium flowing through the temperature control circuit can be heated in a heating device or cooled in a cooling device, depending on requirements. The temperature control medium is controlled via one or more rotary valves.

To prevent internal leakage, a sealing body is arranged in the area of the transition between the fluid channel and the valve core. We have discovered that, depending on the design, the sealing body can cause high frictional forces, which has a negative effect on wear and the required actuating force of the actuator.

### BRIEF SUMMARY

The present disclosure provides a valve that can be manufactured at low cost and has a long service life.

A rotary valve according to the present disclosure comprises a valve housing in which a valve core is rotatably supported, wherein the valve core is provided with a channel structure and wherein the valve housing has a chamber wall into which the flow channels open, wherein the valve core is associated with a sealing element which seals the gap between the chamber wall and the valve core, wherein the channel structure has an inlet channel.

The rotary valve is formed in a simple and cost-effective manner, in particular in that only a single sealing element is associated with the valve core. The sealing element is preferably fastened to the valve core in a positive-locking manner. This enables quick and easy installation. Alternatively, however, it is also conceivable that the sealing element is fixed to the valve core in a material-locking manner or in a positive-locking and material-locking manner.

Preferably, the sealing element has a sealing body formed in one piece. In particular, the sealing element is formed from just a single material, making it particularly easy and cost-effective to manufacture.

The sealing body preferably consists of a fluorosilicone rubber (FVMQ). Fluorosilicone rubbers are resistant to alcohol mixtures and are therefore particularly suitable for transporting coolants containing alcohol.

The sealing element can be formed as a cage. In this design, the sealing element comprises several linear elements that delimit the channel structure of the valve core. Sealing ribs are preferably formed from the sealing element, which extend in the longitudinal direction of the valve core and point in the direction of the chamber wall. The design of the sealing ribs results in a linear contact of the sealing element with the chamber wall of the valve housing and thus in a high sealing effect.

The cage-like design of the sealing element makes it possible to form the sealing element in one piece and thus manufacture it cost-effectively.

Preferably, the sealing element delimits the channel structure in that the sealing ribs of the sealing element are guided around the openings of the channel structure.

The inlet channel can be trapezoidal in shape. In this design, the inlet channel widens in the direction of the chamber wall so that flow into the inlet channel is possible over a large angular range of the valve core. This allows more valve positions to be controlled. Preferably, the cross-section of the inlet channel widens in the direction of the chamber wall.

The valve core is preferably connected to an actuator. The actuator can comprise an electric motor that rotates the valve core inside the valve housing.

A valve cover can be arranged between the valve core and the actuator, wherein the valve core, the valve cover and the actuator form a pre-assembled unit. This design enables quick and cost-effective assembly of the valve core, actuator and valve cover.

The valve housing can comprise an upper part and a lower part, wherein the flow channels are formed in the upper part. Preferably, the valve housing is formed of plastic and, in particular, the upper part can be formed as an injection-molded part. The lower part can be formed flat, wherein, according to an advantageous embodiment, a further flow channel is formed in the lower part, which interacts with a channel arranged in the longitudinal axis of the valve core.

### BRIEF DESCRIPTION OF THE DRAWINGS

Some embodiments of a rotary valve according to the present disclosure are explained in more detail below with reference to the figures.

These show, in each case schematically:

FIG. 1 a rotary valve;

FIG. 2 the valve core, the valve cover and the actuator as a pre-assembled unit;

FIG. 3 the valve housing;

FIG. 4 the valve housing with upper and lower part;

FIG. 5 the valve core in section;

FIG. 6 the valve core with sealing element;

FIG. 7 the sealing element.

### DETAILED DESCRIPTION

The figures show a rotary valve 1, comprising a valve housing 3 provided with flow channels 2, in which valve housing a valve core 4 is rotatably supported. The rotary valve 1 is part of a pipe arrangement and is used in a cooling circuit to control the coolant flow. A cooling fluid can flow in and out of the rotary valve 1 through the flow channels 2 in the valve housing 3. The channel structure 5 in the valve core 4 controls the coolant flow, wherein different cooling circuits can be controlled, the volume flow of the coolant can be regulated, and the flow direction of the coolant can be adjusted.

The coolant flow is adjusted by turning the valve core 4, wherein the torque required for turning is provided by an actuator 11 mounted on the valve core 4.

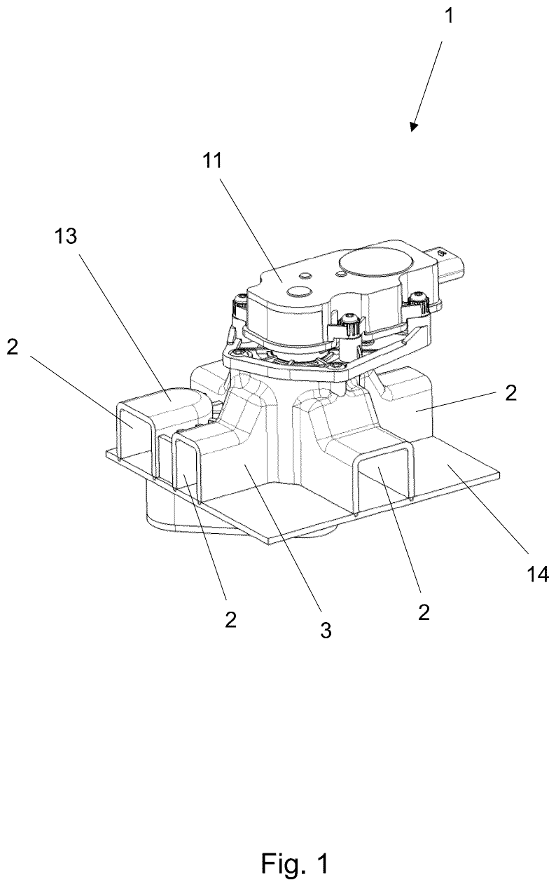

FIG. 1 shows a general view of the rotary valve 1. The valve housing 3 and the actuator 11 can be seen. The valve housing 3 comprises an upper part 13 and a lower part 14, wherein the flow channels 2 are formed in the upper part 13 and covered on the underside by the lower part 14. The upper part 13 and the lower part 14 of the valve housing 3 are formed of plastic and manufactured by injection molding.

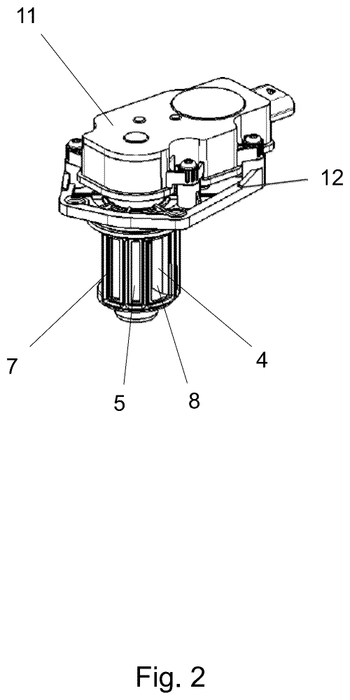

FIG. 2 shows the valve core 4, which forms a pre-assembled unit with a valve cover 12 and the actuator 11.

The valve core 4 is formed essentially cylindrical and is non-rotatably connected to the actuator 11 via a drive shaft 21 arranged along the longitudinal axis. A valve cover 12 is arranged between the valve core 4 and the actuator 11, wherein the actuator 11 is in turn non-rotatably connected to the valve cover 12. To assemble the rotary valve 1, the pre-assembled unit consisting of valve core 4, actuator 11 and valve cover 12 is inserted into the valve housing 3 and the valve housing 3 is firmly connected to the valve cover 12 via a screw connection, wherein alternative connection types, such as an adhesive connection, are also conceivable.

The drive shaft 21 of the valve core 4 protrudes through an opening introduced in the valve cover 12, wherein the gap between the valve cover 12 and the drive shaft 21 is closed by a seal. The actuator 11 comprises an electric motor and a gearbox, via which the torque for turning the valve core 4 is applied.

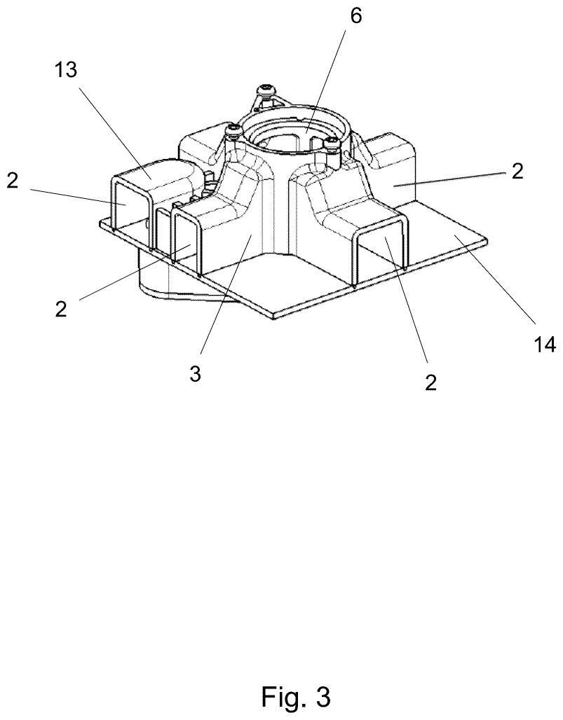

FIG. 3 shows the valve housing 3 of the rotary valve 1, consisting of the upper part 13 and the lower part 14. The flow channels 2 are formed in the upper part 13 and covered on the underside by the lower part 14.

The valve housing 3 delimits a space in which the valve core 4 can be accommodated. The valve housing 3 has a chamber wall 6 into which the flow channels 2 open. Depending on the position of the valve core 4, the channel structure 5 incorporated in the valve core 4 causes an overlap with the flow channels 2, so that cooling media can be directed through the flow channels 2 in different ways depending on the position of the valve core 4.

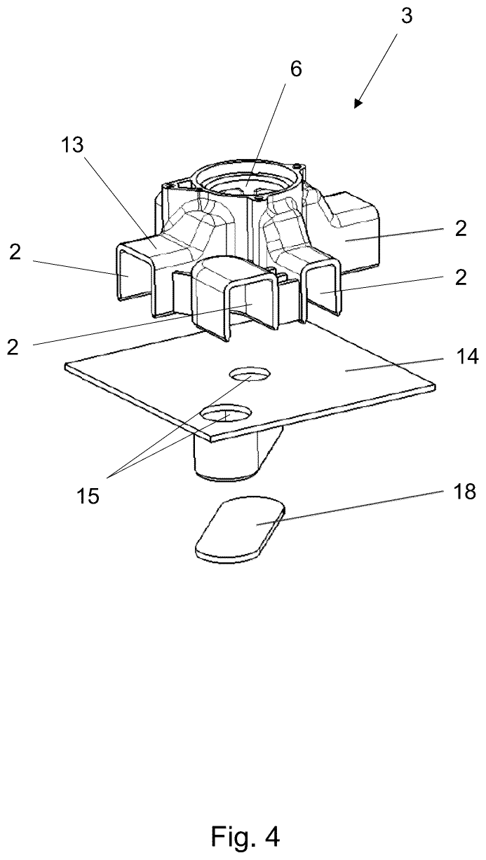

FIG. 4 shows an exploded view of the valve housing 3 shown in FIG. 3. It can be seen that a further flow channel 15 is formed in the lower part 14, which flow channel interacts with a channel 17 arranged in the longitudinal axis 16 of the valve core 4. The further flow channel 15 is closed on the underside by a channel cover 18. This design enables particularly cost-effective production of the lower part 14 or the valve housing 3. Like the upper part 13, the lower part 14 is formed of plastic and manufactured by injection molding.

The upper part 13 and the lower part 14 are joined together in a material-locking manner, for example by ultrasonic welding. It is also conceivable that the upper part 13 and the lower part 14 are connected to each other in a positive-locking manner, for example via a clip connection. Sealing elements are preferably provided between the upper part 13 and the lower part 14 in the case of a positive-locking connection to seal the gap in the upper part 13 and the lower part 14.

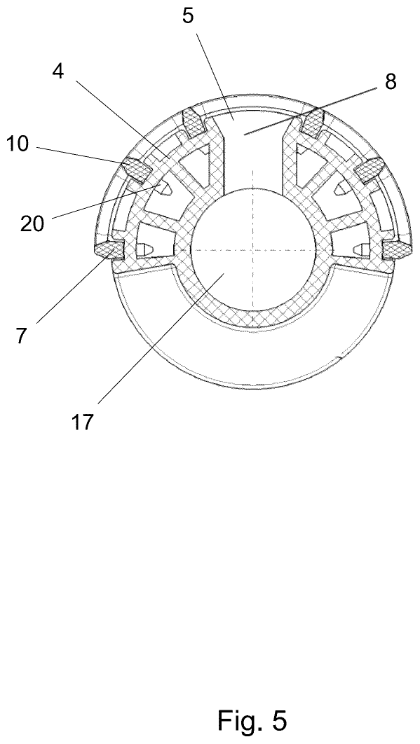

FIG. 5 shows the valve core 4 in cross-section. In this figure it can be seen that the channel structure 5 has an inlet channel 8, wherein the inlet channel 8 is trapezoidal in shape. The inlet channel 8 is connected to the channel 17 arranged in the longitudinal axis 16 of the valve core 4 in a flow-conducting manner.

A sealing element 7 is associated with the valve core 4, which sealing element seals the gap between the chamber wall 6 and the valve core 4. The sealing element has a sealing body 9 formed in one piece and made of fluorosilicone rubber (FVMQ). The sealing element 7 is formed as a cage and delimits the channel structure 5 in that the webs of the sealing element 7 are arranged along the edges of the channel structure 5.

Sealing ribs 10 are formed from the sealing element 7, which extend in the longitudinal direction of the valve core 4 and point in the direction of the chamber wall 6.

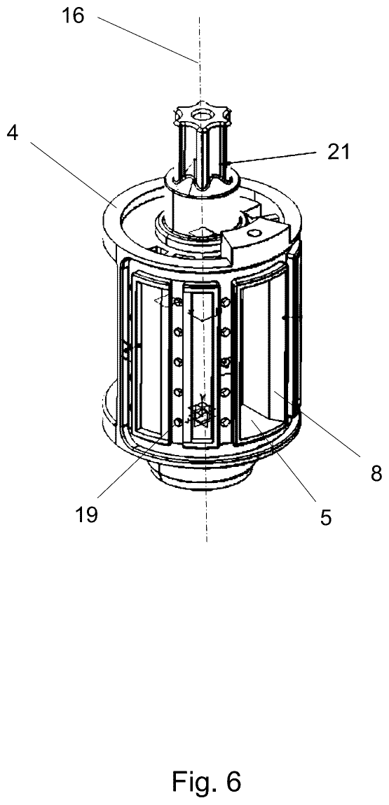

FIG. 6 shows the valve core 4 in detail without sealing element 7. To accommodate the sealing element 7, recesses 19 are introduced in the valve core 4, which serve to accommodate the sealing element 7 in a positive-locking manner. The recesses 19 form an undercut for the positive-locking accommodation.

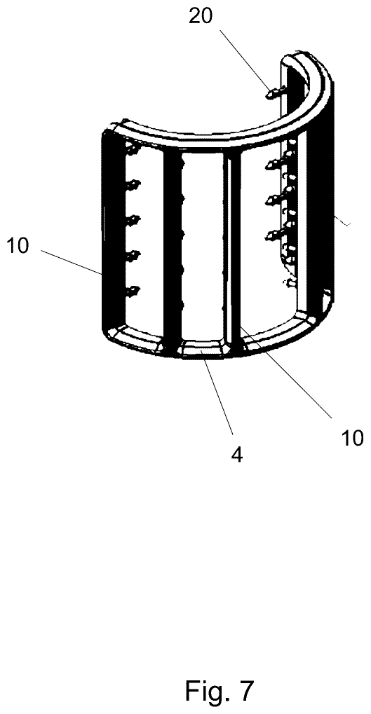

Finally, FIG. 7 shows the sealing element 7. The sealing ribs 10 can be seen extending in the longitudinal direction of the valve core 4 and pointing towards the chamber wall 6. Furthermore, projections 20 can be seen which are formed mushroom-shaped and which are inserted into the corresponding recesses 19 of the valve core 4 to form a positive-locking connection between the sealing element 7 and the valve core 4. As a result, the valve core 4 with the sealing element 7 can be manufactured quickly and cost-effectively.

1. A rotary valve, comprising:
a valve housing which is provided with flow channels;
a valve core rotatably supported in the valve housing, wherein the valve core is provided with a channel structure having an inlet channel, and wherein the valve housing has a chamber wall into which the flow channels open; and
a sealing element associated with the valve core, wherein the sealing element seals the gap between the chamber wall and the valve core.

2. The rotary valve according to claim 1, wherein the sealing element has a sealing body formed in one piece.

3. The rotary valve according to claim 1, wherein the sealing body is formed of a fluorosilicone rubber.

4. The rotary valve according to claim 1, wherein the sealing element is formed as a cage.

5. The rotary valve according to claim 1, wherein sealing ribs are formed from the sealing element, which extend in the longitudinal direction of the valve core and point in the direction of the chamber wall.

6. The rotary valve according to claim 1, wherein the sealing element is fixed to the valve core in a positive-locking manner.

7. The rotary valve according to claim 1, wherein the sealing element delimits the channel structure.

8. The rotary valve according to claim 1, wherein the inlet channel is trapezoidal in shape.

9. The rotary valve according to claim 1, wherein the cross-section of the inlet channel widens in the direction of the chamber wall.

10. The rotary valve according to claim 1, wherein the valve core is connected to an actuator.

11. The rotary valve according to claim 10, wherein a valve cover is arranged between the valve core and the actuator, wherein the valve core, the valve cover and the actuator form a pre-assembled unit.

12. The rotary valve according to claim 1, wherein the valve housing comprises an upper part and a lower part, wherein the flow channels are formed in the upper part.

13. The rotary valve according to claim 12, wherein, in the lower part, a further flow channel is formed and cooperates with a channel arranged in the longitudinal axis of the valve core.
